(19) United States
(12) Patent Application Publication
(10) Pub. No.: US 2025/0224230 A1
(43) Pub. Date: Jul. 10, 2025

(54) LASER LEVEL

(71) Applicant: RAYSAIN CO., LTD., Taichung (TW)

(72) Inventors: MIN-HSUAN HO, Taichung (TW); MENG-WEN HO, Taichung (TW)

(21) Appl. No.: 18/820,302

(22) Filed: Aug. 30, 2024

(30) Foreign Application Priority Data
Jan. 10, 2024 (TW) 113200353

(51) Int. Cl. G01C 15/00

(52) U.S. Cl. CPC G01C 15/002

(57) ABSTRACT

A laser level includes a housing, a base, a movable platform, a connecting seat, and a level adjustment module. The base has a lower seat and an upper seat. The lower seat has a pair of electric motors connected with a pair of lift member. The upper seat has a receiving groove. The movable platform has a receiving seat and a pair of spherical grooves for receiving the lift members. A level tilt sensor and a laser module are provided on the connecting seat. When in use, the level tilt sensor detects the tilt angle, and the electric motors are controlled by the level adjustment module to adjust the height of the respective lift members, so as to complete the leveling process.

### FIELD OF THE INVENTION

The present invention relates to a laser instrument, and more particularly, to a laser level.

### BACKGROUND OF THE INVENTION

In general, a conventional laser level projects laser light points for measurement, instead of existing levels with pendulum or plumb and has an automatic leveling function, thereby saving construction time and improving construction quality.

However, the conventional laser level has a complicated structure and heavy weight, which reduces the speed of leveling. Accordingly, the inventor of the present invention has devoted himself based on his many years of practical experiences to solve these problems.

### SUMMARY OF THE INVENTION

The primary object of the present invention is to provide a laser level that can perform a leveling process quickly.

In order to achieve the foregoing object, the laser level provided by the present invention comprises a housing, a base, a movable platform, a connecting seat, and a control unit. The housing has an accommodation space. The base has a lower seat and an upper seat. A pair of electric motors, a pair of screw rods and a pair of lift member are provided between the upper seat and the lower seat. The electric motors are each connected to a worm. The lift members each include a lift post and a worm wheel. The lift posts of the lift members are screwed to the screw rods, respectively. A spherical head is provided on top of the lift post. The worm wheel is sleeved on the lift post. A threaded portion is provided on a lower outer surface of the worm wheel. The threaded portion is engaged with the worm. The upper seat is arranged on the lower seat. A top of the upper seat has a tapered receiving groove. The movable platform is located above the base. The movable platform includes a tapered receiving seat and a pair of spherical grooves. The receiving seat is received in the receiving groove. The spherical grooves are configured for receiving the spherical heads, respectively. The connecting seat is located above the movable platform. A level tilt sensor is provided in the connecting seat. A laser module is provided on an outside of the connecting seat. The control unit is electrically connected to the electric motors and the level tilt sensor. The control unit includes a level adjustment module.

In the laser level provided by the present invention, the level tilt sensor detects the tilt angle, and the electric motors are controlled by the level adjustment module to adjust the height of the respective lift members, thereby adjusting the level of the movable platform and the laser module, such that the leveling process of the laser level is completed.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a perspective view of the movable platform according to the preferred embodiment of the present invention;

FIG. 4 is a block diagram of the control unit according to the preferred embodiment of the present invention;

FIG. 5 is a schematic view according to the preferred embodiment of the present invention when in use;

FIG. 6 is a schematic view according to the preferred embodiment of the present invention when in use, illustrating the leveling status and the level cursor of the laser level;

FIG. 7 is another schematic view according to the preferred embodiment of the present invention when in use, illustrating the leveling status and the level cursor of the laser level; and

FIG. 8 is a further schematic view according to the preferred embodiment of the present invention when in use, illustrating the leveling status and the level cursor of the laser level.

### DETAILED DESCRIPTION OF THE PREFERRED EMBODIMENTS

Embodiments of the present invention will now be described, by way of example with reference to the accompanying drawings.

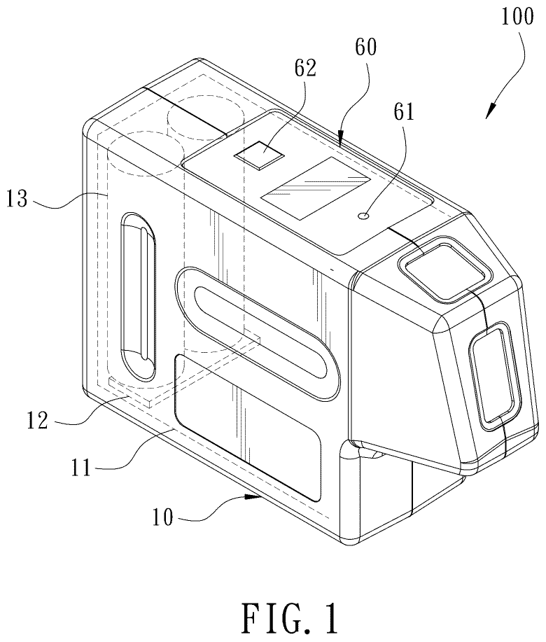

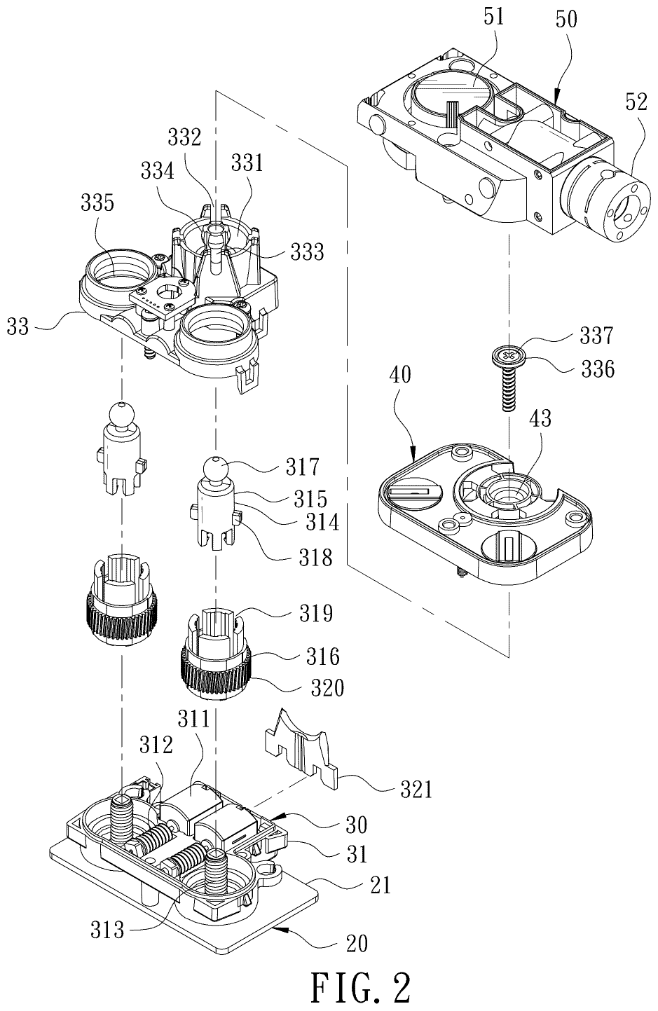

FIG. 1 is a perspective view according to a preferred embodiment of the present invention. FIG. 2 is an exploded view according to the preferred embodiment of the present invention. The present invention discloses a laser level 100, comprising a housing 10, a control unit 20, a base 30, a movable platform 40, a connecting seat 50, and a display screen 60.

The housing 10 has an accommodation space 11 and a battery holder 12 therein. At least one battery 13 is mounted to the battery holder 12.

The control unit 20 includes a motherboard 21. The motherboard 21 is fixed in the accommodation space 11.

The base 30 is fixed on the motherboard 21. The base 30 is hollow and includes a lower seat 31 and an upper seat 33.

A pair of electric motors 311, a pair of screw rods 313, a pair of lift members 314 and an upright plate 321 are provided between the lower seat 31 and the upper seat 33. The electric motors 311 are arranged in parallel and electrically connected to the motherboard 21. The electric motors 311 each have an output shaft connected to a worm 312. The screw rods 313 are vertically disposed on the lower seat 31 and located outside of the respective electric motors 311. The lift members 314 each include a lift post 315 and a worm wheel 316. The lift posts 315 of the lift members 314 are screwed to the screw rods 313, respectively. A spherical head 317 is provided on top of the lift post 315. A pair of restricting blocks 318 are provided on the outside of the lift post 315. The worm wheel 316 is sleeved on the lift post 315. The worm wheel 316 is formed with a few guide grooves 319. The restricting blocks 318 are seated in the guide groves 319, respectively. A threaded portion 320 is provided on the lower outer surface of the worm wheel 316. The threaded portion 320 is engaged with the worm 312. Thereby, when the electric motors 311 rotate, the worm wheels 316 are driven to rotate through the worms 312, and then the lift posts 315 are moved through the guide grooves 319 and the restricting blocks 318. Finally, the lift posts 315 are raised or lowered by the respective screw rods 313 to adjust the height of the lift members 314. The upright plate 321 is vertically mounted on the lower seat 31 and is against the inner side of the upper seat 33. The upright plate 321 is located on one side of the electric motors 311 opposite the worm 312.

The upper seat 33 is mounted above the lower seat 31. The top of the upper seat 33 has a tapered receiving groove 331. The wall of the receiving groove 331 has four restricting grooves 332. The restricting grooves 332 are arranged at equal intervals. A receiving post 333 is at the center of the receiving groove 331. A few curved positioning blocks 334 are on the top periphery of the receiving post 333. The upper seat 33 has a pair of circular through holes 335 for the lift members 314 to pass through the upper seat 33. The center of the receiving groove 331 and the extension lines of the restricting grooves 332 intersect with the axis of the through hole 335.

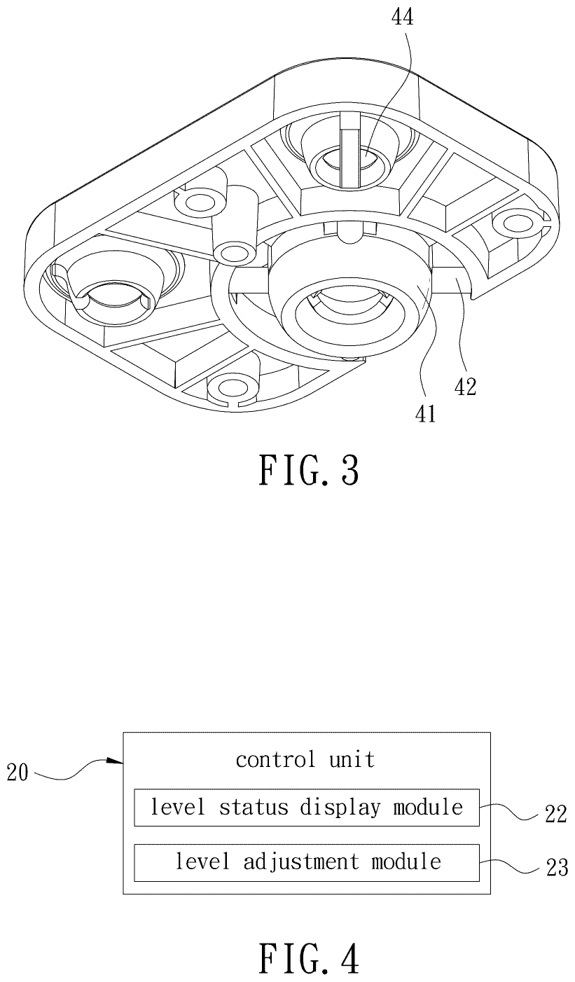

The movable platform 40, referring to FIG. 3, is located above the base 30. The movable platform 40 includes a tapered receiving seat 41, four restricting shafts 42, a positioning groove 43, and a pair of spherical grooves 44. The receiving seat 41 is located on the bottom of the movable platform 40 and received in the receiving groove 331. The restricting shafts 42 are integrally formed with the circumferential side of the receiving seat 41. The restricting shafts 42 correspond to and are arranged in the restricting grooves 332. The positioning groove 43 is located on the top of the movable platform 40 and accommodates the positioning blocks 334. The spherical grooves 44 are configured for receiving the spherical heads 317. When the lift members 314 are raised or lowered, the level of the movable platform 40 is adjusted by means of the spherical heads 317 and the spherical grooves 44, and the adjustment angle and direction of the movable platform 40 are limited by means of the receiving seat 41, the restricting shafts 42, the positioning groove 43, the receiving groove 331, the restricting groove 332 and the positioning blocks 334. In this embodiment, after the movable platform 40 is installed, the receiving post 333 is further fitted with a washer 336 and locked with a screw 337, so that the movable platform 40 is pressed against the upper seat 33.

The connecting seat 50 is located above the movable platform 40 and is linked with the movable platform 40. A level tilt sensor 51 is in the connecting seat 50. The level tilt sensor 51 is electrically connected to the motherboard 21. A laser module 52 is on the outside of the connecting seat 50. In this embodiment, the laser module 52 is a three-point laser module. The laser module 52 is capable of emitting laser light points in the upward, downward, and level directions and passing through the corresponding light-transmitting mirror of the housing 10.

The display screen 60 is on the top of the housing 10 and is electrically connected to the motherboard 21. An indicator light 61 and a power switch 62 are on two sides of the display screen 60.

The control unit 20, referring to FIG. 4, includes a level status display module 22 and a level adjustment module 23. The control unit 20 receives a potential signal from the level tilt sensor 51. The level status display module 22 displays the leveling status and the level cursor of the laser level 100. The level adjustment module 23 controls the heights of the electric motors 311 and the lift members 314, thereby adjusting the level of the movable platform 40.

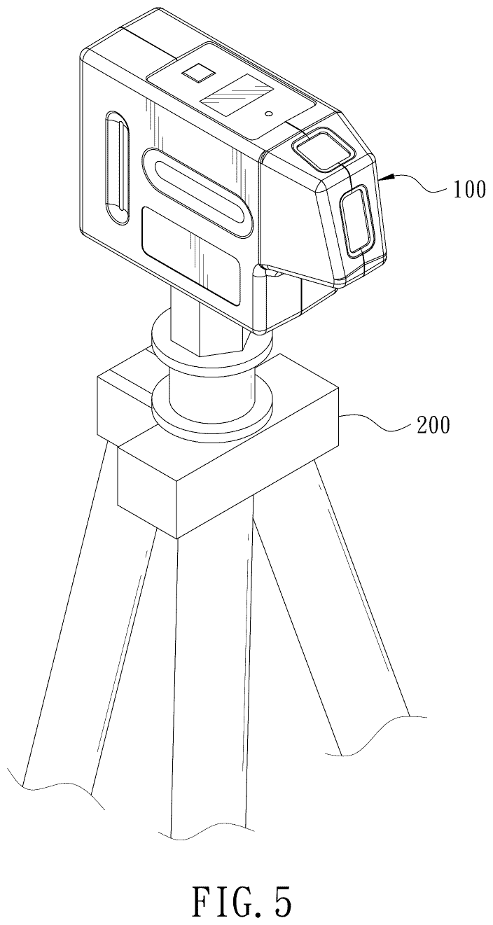

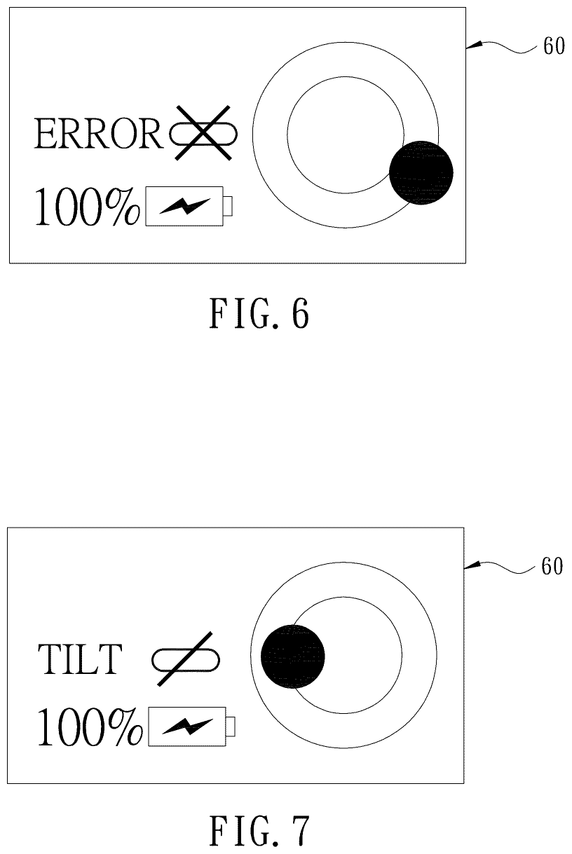

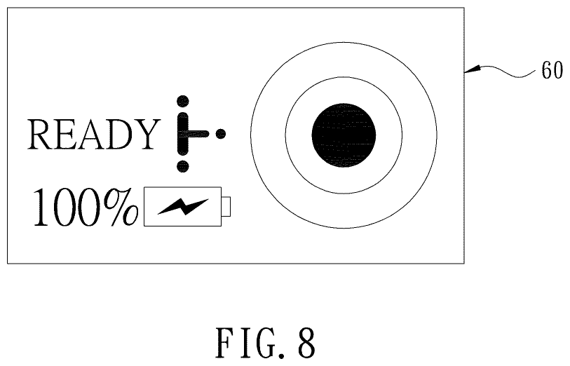

As shown in FIG. 5, when using the laser level 100, set the invention on a tripod 200, and then turn on switch 62, the level adjustment module 23 starts the leveling process. As shown in FIG. 6, when the laser level 100 is placed at a position where the tilt angle is greater than 5 degrees, the display screen 60 displays that the leveling status is ERROR, the level cursor is out of circle, and the indicator light 61 flashes quickly until the tilt angle is less than 5 degrees. As shown in FIG. 7, when the laser level 100 is placed at a position where the tilt angle is less than 5 degrees, the display screen 60 displays that the leveling status is TILT, the level cursor is moving, and the indicator light 61 flashes slowly. The level adjustment module 23 will adjust the level of the movable platform 40. As shown in FIG. 8, when the laser level 100 has finished the leveling, the display screen 60 displays that the leveling status is READY and the level cursor is centered, and the indicator light 61 is always on, thereby quickly completing the leveling process of the laser level 100.

The movable platform 40 is positioned through the receiving seat 41, the restricting shafts 42 and the positioning grooves 43 to be engaged with the receiving groove 331, the restricting grooves 332 and the positioning blocks 334 of the upper seat 33 respectively, so as to restrict the adjustment angle and direction of the movable platform 40. The lift members 314 can achieve a good leveling effect when they are raised or lowered. The upright plate 321 is against the inner side of the upper seat 33 to stabilize the upper seat 33, thereby improving the stability of the movable platform 40.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A laser level, comprising:
a housing, having an accommodation space;
a base, disposed in the accommodation space, the base having a lower seat and an upper seat;
the lower seat including a pair of electric motors, a pair of screw rods and a pair of lift member, the electric motors being each connected to a worm, the lift members each including a lift post and a worm wheel, the lift posts of the lift members being screwed to the screw rods respectively, a spherical head being provided on top of the lift post, the worm wheel being sleeved on the lift post, a threaded portion being provided on a lower outer surface of the worm wheel, the threaded portion being engaged with the worm;
the upper seat, located above the lower seat, a top of the upper seat having a tapered receiving groove;
a movable platform, located above the base, the movable platform including a tapered receiving seat and a pair of spherical grooves, the receiving seat being received in the receiving groove, the spherical grooves being configured for receiving the spherical heads;
a connecting seat, located above the movable platform, a level tilt sensor being provided in the connecting seat, a laser module being provided on an outside of the connecting seat;
a control unit, electrically connected to the electric motors and the level tilt sensor, the control unit including a level adjustment module.

2. The laser level as claimed in claim 1, wherein the screw rods are located outside the respective electric motors.

3. The laser level as claimed in claim 1, wherein a pair of restricting blocks are provided on an outside of the lift post, the worm wheel is formed with a plurality of guide grooves, and the restricting blocks are seated in the guide groves.

4. The laser level as claimed in claim 1, wherein the upper seat has a pair of circular through holes.

5. The laser level as claimed in claim 1, wherein a wall of the receiving groove has four restricting grooves, the restricting grooves are arranged at equal intervals, the movable platform further has four restricting shafts, the restricting shafts are integrally formed with a circumferential side of the receiving seat, and the restricting shafts correspond to and are arranged in the restricting grooves.

6. The laser level as claimed in claim 1, wherein a receiving post is disposed at a center of the receiving groove, a plurality of curved positioning blocks are disposed on a top periphery of the receiving post, the movable platform further has a positioning groove, and the positioning groove is formed with the positioning blocks.

7. The laser level as claimed in claim 6, wherein the receiving post is fitted with a washer and locked with a screw.

8. The laser level as claimed in claim 1, wherein the lower seat further has an upright plate, the upright plate is vertically mounted on the lower seat and is against an inner side of the upper seat.

9. The laser level as claimed in claim 1, wherein the control unit includes a level status display module, the laser level further comprises a display screen on a top of the housing, the display screen is electrically connected to the control unit, and an indicator light and a power switch are provided on two sides of the display screen.
